(19) United States
(12) Patent Application Publication
(10) Pub. No.: US 2005/0013390 A1
(43) Pub. Date: Jan. 20, 2005

(54) Hybrid UWB receiver with matched filters and pulse correlator

(76) Inventor: Anders Fredrik Tufvesson, Lund (SE)

Correspondence Address: Patent Department;Mitsubishi Electric Research Laboratories, Inc., 201 Broadway, Cambridge, MA, 02139, US

(21) Appl. No.: 10/619,021

(22) Filed: Jul. 14, 2003

(51) Int. Cl. H04L 27/06

(52) U.S. Cl. 375/340

(57) ABSTRACT

A hybrid UWB receiver detects a transmitted data symbol in an ultra-wide-bandwidth communications system. A filter is matched to a received reference signal and data signal corresponding to the transmitted data symbol. A delay block is connected to an output of the filter. A multiplier is connected to an output of the delay block and an output of the filter. An integrator is connected to an output of the multiplier. Then, a largest output of the integrator is selected to provide a basic building block of an ultra-wide-bandwidth the receiver to detect a received data symbol corresponding to the transmitted data symbol. Multiple basic building block can then be interconnected to construct the hybrid receiver.

### FIELD OF THE INVENTION

This invention relates generally to ultra-wide-band (UWB) communications, and more particularly to UWB receivers.

### BACKGROUND OF THE INVENTION

With the release of the “First Report and Order,” Feb. 14^{th}, 2002, by the United States Federal Communications Commission (FCC), interest in ultra-wide-bandwidth (UWB) communication systems has increased. Ultra-wide-bandwidth (UWB) is a form of spread-spectrum radio communication. In UWB systems, the bandwidth is much wider than the bandwidth of the underlying data signal. However, unlike a conventional spread-spectrum system, where the signal is, more or less, of constant amplitude, a UWB signal consists of a sequence of very short pulses spread over a very wide frequency range. Therefore, the terms “UWB” and “impulse radio” are often used synonymously. The spreading waveform is a pattern of short pulses that is modulated to encode the data signals.

A number of techniques are known for spreading the bandwidth of a wireless signal over a large frequency range. Most notable among those are time-hopped impulse radio (TH-IR) and direct-sequence spreading (DSS). These techniques are effectively equivalent when optimum modulation and multiple-access schemes are employed. Modulation techniques can include pulse-position modulation (PPM) and pulse amplitude modulation (PAM).

Because multiple pulses are used, UWB receivers need to resolve many multi-path components in the received signal. In the prior art, two basic receiver schemes are known, namely rake receiver with matched filters, see Choi et al., “Performance of ultra-wideband communications with suboptimal Receivers in multi-path channels,” IEEE JSAC, Vol 20, No 9, pp. 1754-1766, December 2002, and a transmitted reference scheme that uses a pulse correlator, see Hoctor et al., “Delay-hopped transmitted reference RF communications,” IEEE Conf. on Ultra Wideband Systems and Technologies, pp 265-270, 2002.

The RAKE approach requires channel estimation for the combining of a selected number of multi-path components. Because the receiver structure is fairly complex, only the strongest, or a few of the strongest multi-path components are used to form the decision variable. That means that the receiver does not fully resolve all multi-path components, and the performance is less than ideal due to the inherent channel estimation and combining problem. Increasing the number of rake fingers increases the complexity and cost of the system.

In transmitted reference schemes, pairs of transmitted pulses are used for each symbol. The first pulse is not modulated by the data and is called the reference pulse. The second pulse is modulated by the data and is called the data pulse. The reference and data pulses are separated by a time delay. The receiver uses a pulse-pair correlator to recover the transmitted data symbols. In the correlator, the pulse inputs to a multiplier are time-aligned, which results in a large peak. Thereafter, each incoming multi-path component results in a new peak.

The different peaks all have the same phase. The phase is determined by the value of the data symbol, and therefore they can be summed by an integrator during a time, T_{g}. This time corresponds to an excess delay of the channel. The integrator outputs are then correlated with the different signal/code alternatives to make a decision on the transmitted data symbols. As an advantage, this scheme is less complex and is able to combine the energy from different multi-path components without channel estimation. Unfortunately, the output of the multiplier has a very poor signal-to-noise ratio (SNR) due to non-linear operations on noise terms when forming the decision variable and due to the inherent energy loss when transmitting the reference pulse. That results in large noise-times-noise terms that are integrated over the time T_{g}. The effects of noise can be reduced when the data pulse is multiplied by an average of the reference pulse. However, overall, the transmitted reference scheme has a worse performance when compared with the ideal RAKE approach, due to the noise products.

Therefore, there is a need for an UWB receiver that has reduced complexity, does not require channel estimation, and that is not subject to the effects of multi-path components and noise.

### SUMMARY OF THE INVENTION

A hybrid UWB receiver detects a transmitted data symbol in an ultra-wide-bandwidth communications system.

A filter is matched to a received reference signal and data signal corresponding to the transmitted data symbol. A delay block is connected to an output of the filter.

A multiplier is connected to an output of the delay block and an output of the filter. An integrator is connected to an output of the multiplier.

Then, a largest output of the integrator is selected to provide a basic building block of an ultra-wide-bandwidth the receiver to detect a received data symbol corresponding to the transmitted data symbol.

Multiple basic building blocks can then be interconnected to construct the hybrid receiver.

### BRIEF DESCRIPTION OF THE DRAWINGS

FIG. 1 is a block diagram of a UWB receiver building block according to the invention;

FIG. 2 is block diagram of a UWB receiver with multiple building blocks according to the invention;

FIG. 3 is a block diagram of an alternative UWB receiver with multiple building blocks according to the invention.

### DETAILED DESCRIPTION OF THE PREFERRED EMBODIMENT

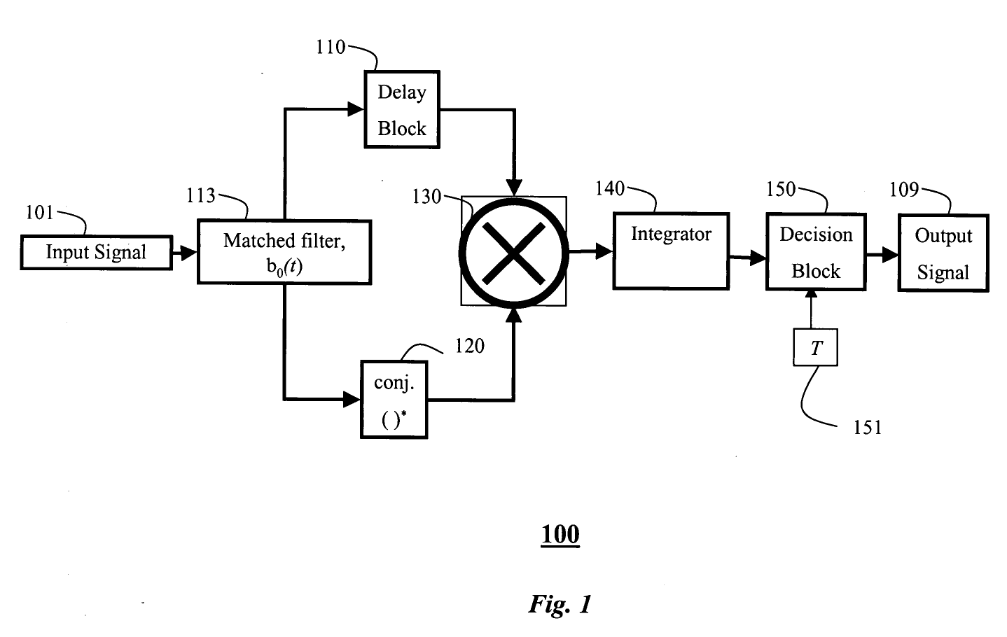

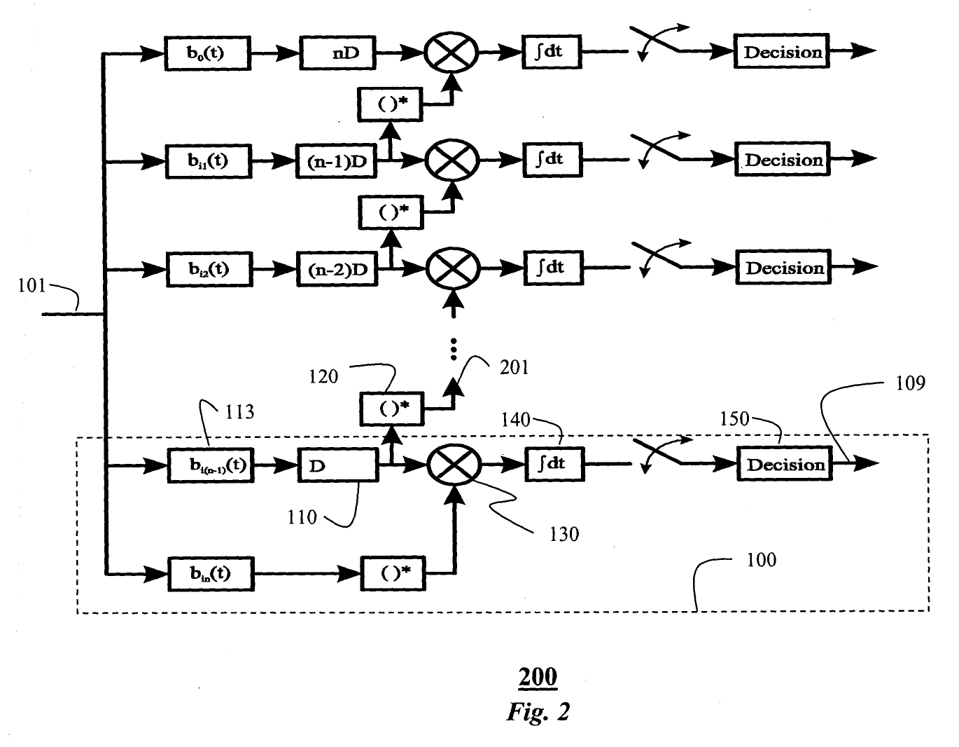

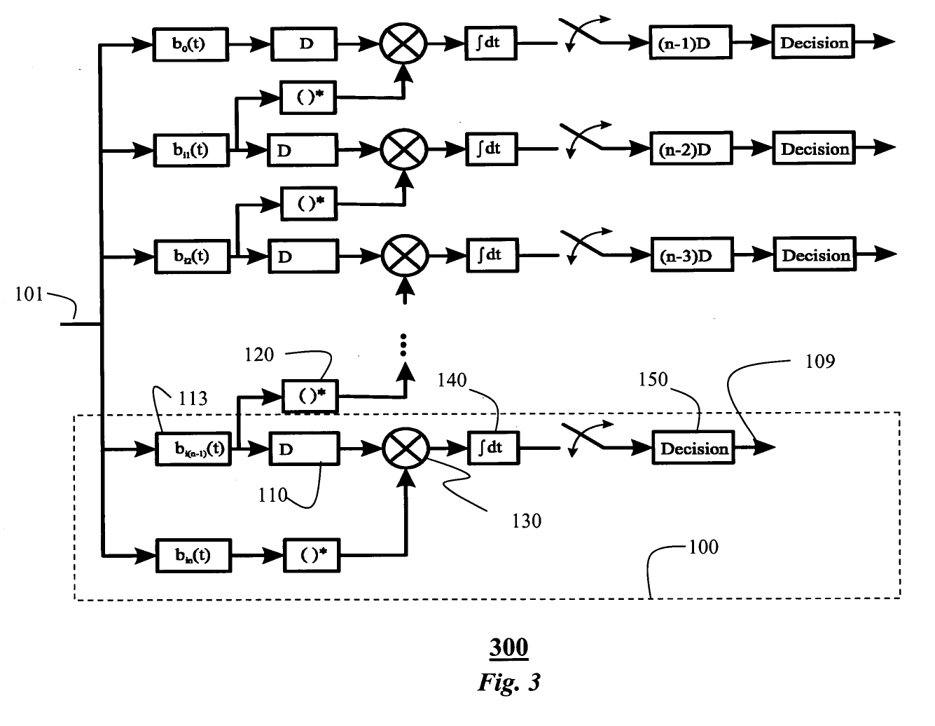

FIG. 1 shows a basic building block 100 of an ultra-wide-bandwidth (UWB) receiver according to the invention. As shown in FIGS. 2 and 3, multiple building blocks 100 can be interconnected to provide UWB receiver structures 200 and 300 capable of capturing energy from different multi-paths signal components without the need for channel estimation. The hybrid matched filter correlation receiver according to the invention decreases significantly the performance loss due to the noise-times-noise terms as in conventional transmitted reference-base UWB receivers.

Receiver Structure

The basic building block 100 includes a matched filter 113, matched to signal alternatives and having an input connected to receive an input signal 101, a delay block 110 and complex conjugate block 120 each having their input connected to receive the output of the matched filter 113. The outputs of the delay block and the conjugate block are connected to a multiplier 130. The output of the multiplier is connected to an integrator 140, which in turn is connected to a decision block 150 to generate an output signal 109.

Alternatively, the conjugate block can be placed at a branch with the delay block 110, and thus with a direct path between the matched filter 113 and the multiplier 130.

Receiver Operation

The input signal 101 includes a reference signal and one or more modulated data signals for each transmitted data symbol. The received signal is delayed 110 so that the reference signal is time-aligned with the data signal at the input to the multiplier 130. The output of the multiplier 130 is integrated 140 so that a decision 150 can be made on the output signal 109. As an advantage, this structure is able to capture the energy from different multi-path components without a need for channel estimation.

The main differences compared to prior art rake receivers are as follows. There are no “parallel” branches for each multi-path component Signals from different multi-path components are automatically time-aligned and combined according to their energy.

The main differences compared to prior art transmitted reference schemes are as follows. There is a fixed delay 110 between the reference signal and the modulated data signal. Multiplication 130 is performed only after the desired processing gain is achieved by the matched filters 120. There is only one multiplier 130 for the basic receiver block structure. In this way, the terms in the multiplication have a much higher SNR, and the strong influence from the noise-times-noise terms can be decreased or almost eliminated. The SNR of the terms is increased by approximately a factor Nₚ, where Nₚ is the number of pulses per symbol, compared to the conventional transmitted reference scheme.

Hybrid Correlation

In its basic form, input signal 101 is composed as
s(t)=b₀(t)+bᵢ(t−D),
where b are the so called base signals, b₀(t) is the reference signal, and bᵢ(t−D) represent the data signals. Different signaling alternatives i can be used, e.g., conventional pulse position modulated signals, pulse amplitude modulation, pulse phase modulation, and the like.

Note that the data signals can differ in phase. Also, if b₁(t)=b₀(t) and b₂(t)=−b₀(t), as shown in FIG. 1, then the signaling corresponds to the transmitted reference scheme as described above. If b₁(t)=b₀(t) and b₂(t)=0, the signaling corresponds to on-off keying.

The filter 113 is matched to the base signals b, including the reference signal and the data signals. The filtered data signals are time-aligned with the reference signal according to the delay D of the delay block 110. The multiplication 130, together with the matched filter 113, provide gain for the received signal 101.

The output produced by the multiplier 130 is integrated ∫dt 140 over a finite interval Tᵢₙₜ, determined by the excess delay and signal duration to achieve a maximum signal-to-noise ratio. At a correct decision instant, the outputs of the integrator 140 can be compared to a threshold T 151 to select 150 the most probable signal 109.

It should be noted that the transmitted signal is not restricted to one reference signal and one modulated data signal. In order to minimize energy loss due to the reference signal, several modulated data signals can be transmitted successively as
s(t)=b₀(t)+b¹ᵢ₁(t−D)+b²ᵢ₂(t−2D)+ . . . +bⁿᵢₙ(t−nD),
where bⁿᵢₙ represents the base signal transmitted with delay nD. Preferably, differential coding between successive base signals is then applied to minimize the influence of a time-varying channel.

FIG. 2 shows a general form of the UWB receiver 200 according to the invention.

In FIG. 3 an alternative of the general form of the receiver structure is given for the hybrid detection scheme. Here, a next building block, time-wise), is interconnected to a previous building block (time-wise) by feeding the delayed reference signal 201, via the conjugate block 120 to the multiplier 130. As shown in FIG. 3, the delays 110 can be rearranged so that a largest parts of the delays are in the digital domain, i.e., before the decision block 150.

It should be noted that if the input base signals bₙ, differ only in phase, the basic receiver building structure of FIG. 1 can be used also for the general case with more than one modulated data signal for each transmitted reference signal.

If the delay is shorter than the excess delay of the channel, inter-symbol-interference (ISI) can occur. For antipodal signaling, the ISI leads to either constructive or destructive interference because the multiplied and integrated signal either has a phase shift of 0 or 180 degrees. If the ISI is severe, then it can be mitigated by traditional equalization methods, before the decision block 150.

The hybrid matched filter correlation receiver according to the invention can be extended to cope with higher data rates by transmitting several orthogonal base signals concurrently. Then there is one receiver chain for each base signal.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

1. An apparatus for detecting a transmitted data symbol in an ultra-wide-bandwidth communications system, comprising:
a filter matched to a received reference signal and data signal corresponding to the transmitted data symbol;
a delay block connected to an output of the filter;
a multiplier connected to an output of the delay block and an output of the filter;
an integrator connected to an output of the multiplier; and
decision means for selecting a largest output of the integrator to provide a basic building block of an ultra-wide-bandwidth the receiver to detect a received data symbol corresponding to the transmitted data symbol.

2. The apparatus of claim 1, in which a conjugate block is connected at a branch between the filter and the multiplier.

3. The apparatus of claim 1, in which the data symbol is pulse position modulated.

4. The apparatus of claim 1, in which the data symbol is pulse amplitude modulated.

5. The apparatus of claim 1, in which the data symbol is pulse phase modulated.

6. The apparatus of claim 1, in which the delay block time-aligns the reference signal with a filtered data signal.

7. The apparatus of claim 1, in which a plurality of data signals are processed in parallel for each reference signal corresponding to one data symbol.

8. The apparatus of claim 1, in which the data symbol is transmitted to the receiver by on-off keying.

9. The apparatus of claim 1, in which the filter is matched to alternatives of the data symbol.

10. The apparatus of claim 1, in which the filter is constructed as a matched filter bank.

11. The apparatus of claim 1, in which the output of the multiplier is integrated over a finite interval determined by an excess delay and signal duration to achieve a maximum signal-to-noise ratio.

12. The apparatus of claim 1, in which a plurality of differently modulated data signals are transmitted successively for each reference signal corresponding to one data symbol.

13. The apparatus of claim 1, in which a plurality of basic building blocks are interconnected by connecting the delay block to the multiplier of a previous basic building block via the conjugate block.

14. The apparatus of claim 1, in which a plurality of basic building blocks are interconnected by connecting the filter to the multiplier of a previous basic building block via the conjugate block.

15. The apparatus of claim 1 further comprising:
an equalizer connected to the output of the integrator to reduce inter-symbol-interference.

16. A method for detecting a transmitted data symbol in an ultra-wide-bandwidth communications system, comprising:
filtering a received reference signal and data signal;
delaying the filtered reference signal to time-align with the filtered data signal;
multiplying the filtered data signal by the delayed reference signal to produce a product;
integrating the product over time;
selecting a largest output of the integrator to provide a basic building block of an ultra-wide-bandwidth the receiver to detect a received data symbol corresponding to the transmitted data symbol.
